(19) United States
(12) Patent Application Publication
(10) Pub. No.: US 2024/0410691 A1
(43) Pub. Date: Dec. 12, 2024

(54) ROTATION ANGLE SENSOR UNIT, COVER FOR A HOUSING OF A ROTATION ANGLE SENSOR UNIT AND METHOD FOR PRODUCING A ROTATION ANGLE SENSOR UNIT

(71) Applicant: HELLA GmbH & Co. KGaA, Lippstadt (DE)

(72) Inventor: Keramettin SEVEN, Lippstadt (DE)

(73) Assignee: HELLA GmbH & Co. KGaA, Lippstadt (DE)

(21) Appl. No.: 18/808,065

(22) Filed: Aug. 18, 2024

Related U.S. Application Data
(63) Continuation of application No. PCT/EP2023/052673, filed on Feb. 3, 2023.

(30) Foreign Application Priority Data
Feb. 17, 2022 (DE) 10 2022 103 731.2

(51) Int. Cl. G01B 21/22

(52) U.S. Cl. CPC G01B 21/22

(57) ABSTRACT

A rotation angle sensor unit for determining a rotation angle between a rotor and a stator. A housing defines a housing volume. The rotor is rotatably mounted in the housing volume. A printed circuit board has the at least one stator attached thereto. A cover for the housing encloses the printed circuit board in the housing volume. The cover has a funnel-shaped ring structure with a funnel upper side facing away from the printed circuit board and a funnel bottom side facing the printed circuit board. The funnel bottom side fixes the printed circuit board in the housing volume and presses against the printed circuit board. A cover for a rotation angle sensor unit and a method for producing a rotation angle sensor unit are also provided.

This nonprovisional application is a continuation of International Application No. PCT/EP2023/052673, which was filed on Feb. 3, 2023, and which claims priority to German Patent Application No. 10 2022 103 731.2, which was filed in Germany on Feb. 17, 2022, and which are both herein incorporated by reference.

### BACKGROUND OF THE INVENTION

### Field of the Invention

The present invention relates to a rotation angle sensor unit for determining a rotation angle between a rotor and a stator, to a cover for a housing of a rotation angle sensor unit, and to a method for producing such a rotation angle sensor unit.

### Description of the Background Art

Inductive rotation angle sensor units are generally known from the state of the art. They are used in motor vehicles, for example, to determine torques such as steering torques. This is becoming necessary more and more because electromotive servo devices are being used increasingly for steering assistance. These require a steering torque value for control. Steering torques can be detected in a steering column by a shaft and in particular by a torsion bar in differential angles and calculated from these. For this purpose, the rotations at the ends of the torsion bar are determined as signals via a suitable arrangement and passed on to evaluation units. The differential angles caused by the torsion can be determined independently of a steering wheel position. Furthermore, it is important for driver assistance systems, for example, to know the steering wheel position. For this purpose, a turning angle of the steering wheel is determined via a rotation angle sensor unit.

EP 2 870 033 B1, which corresponds to US 2015/0168140, which is incorporated herein by reference, describes numerous other variants of known rotation angle sensor units.

To determine the steering angles as accurately as possible, it is important that the position of the printed circuit board in the housing volume remains as stable as possible radially and axially in relation to the rotor. A loss of the relative position causes an incorrect or undetectable sensor signal, which can lead to a safety-relevant error.

In order to achieve the required sensor performance, the central axis of a printed circuit board through-hole must be positioned as coaxially as possible to the central axis of the rotor and must also remain in this position during operation in different operating states and environmental conditions.

### SUMMARY OF THE INVENTION

It is therefore an object of the present invention to at least partially take into account the problem described above. In particular, it is an object of the present invention to reliably maintain the relative position of the printed circuit board to the rotor in the desired position during operation of a rotation angle sensor unit in as simple a manner as possible.

The foregoing object is achieved by a rotation angle sensor unit, a cover, and a method. In this regard, features that are described in relation to the rotation angle sensor unit also apply, of course, in relation to the cover of the invention, to the method of the invention, and conversely in each case, so that with regard to the disclosure, reference is and/or can always be made mutually to the individual aspects of the invention.

According to a first aspect of the present invention, a rotation angle sensor unit for determining a rotation angle between a rotor and a stator is proposed. The rotation angle sensor unit has a housing which defines a housing volume, the rotor which is rotatably mounted in the housing volume, the stator, and a printed circuit board on which the at least one stator is attached. The rotation angle sensor further has a cover for the housing for enclosing the printed circuit board in the housing volume, wherein the cover has a funnel-shaped ring structure with a funnel upper side facing away from the printed circuit board and a funnel bottom side facing the printed circuit board and the funnel bottom side for fixing the printed circuit board in the housing volume presses against the printed circuit board.

Using the funnel-shaped ring structure, a slight holding pressure or a corresponding pretension can always be applied to the circuit board, even during operation of the rotation angle sensor unit. As a result, the circuit board can be held in a simple manner stably in the housing or at the desired position in the housing volume in the radial direction and especially in the axial direction. Separate and/or additional holders and/or pretensioning units can be dispensed with. The solution of the invention can therefore be implemented in a particularly space-saving and simple manner. Nevertheless, the level of complexity of the cover continues to remain relatively low. Generic retaining pins on the cover for holding the printed circuit board can be completely or at least partially dispensed with.

The funnel-shaped ring structure can have a round shape, therefore, a round inner peripheral edge and a round outer peripheral edge. Particularly preferably, the peripheral edges are each designed circular. Nevertheless, it is possible for the funnel-shaped ring structure to also have an angular ring structure in the shape of a funnel or substantially in the shape of a funnel. This means that the inner peripheral edge and/or the outer peripheral edge can also have corners and edges. The ring structure or funnel shape is characterized in particular by the fact that a radially outer area of the ring structure is designed to be higher than a radially inner area of the ring structure when viewed in an axial direction and the radially inner area is designed to be elastically movable in the axial direction by pressing against the printed circuit board, wherein the pretension force by the ring structure onto the printed circuit board is changed by the axial movement.

The funnel-shaped ring structure can be designed as only part of the cover. This means that the funnel-shaped ring structure does not characterize the entire appearance of the cover. In fact, the cover can also have other structural elements formed directly on the ring structure. In other words, the funnel-shaped ring structure should preferably be considered only as part of the cover.

In addition to the one rotor, the rotation angle sensor unit can also have at least one further rotor and in addition to the one stator, the rotation angle sensor unit can also have at least one further stator.

The printed circuit board can be a circuit board or a generic PCB. In addition to the at least one stator, other electrical and/or electronic components are preferably attached to the printed circuit board. The housing can be an open housing shell that is closed by the cover. If the housing is closed, it naturally also has at least one overall housing through-opening through which a shaft and the rotor can extend.

The rotor can be a component unit with a rotor sleeve, a ring-shaped conductor section, and a connector for connecting the rotor ring to the rotor sleeve. However, the end-face conductor section can also be designed to be integral or in one-piece together with the rotor sleeve. The angle of rotation can be the amount of relative rotation between the rotor and the stator. The relative rotation or the angle of rotation can be determined via the rotor and the stator and/or via at least one further rotor and/or via at least one further stator.

The funnel upper side, which faces away from the printed circuit board, can be the outside of the cover, which faces the surroundings of the housing. The funnel bottom side, which faces the printed circuit board or is pressed against it, can be the inner side of the cover, which faces the housing volume and defines a part of the housing volume. Fixing the printed circuit board can be, for example, a frictional holding of and/or an application of pressure to the printed circuit board. The enclosing of the printed circuit board in the housing or housing volume can be that the housing surrounds the printed circuit board in such a way that the printed circuit board cannot be removed from the housing or housing volume without opening the housing and without damage.

In a rotation angle sensor unit, a circular or annular pressure section can be formed on the funnel bottom side for applying pressure to the printed circuit board. The pressure can be transferred uniformly from the cover to the printed circuit board by the ring-shaped pressure section, as a result of which a correspondingly uniform holding force can be applied to the printed circuit board. Consequently, damage and/or destruction to the circuit board can be prevented. The pressure section can be designed in particular in the form of an annular contact surface or in the form of an annular or circular contact edge.

In a rotation angle sensor unit of the invention, it is possible further for the funnel-shaped ring structure to be designed to be elastically deformable. This means that the ring structure can not only be pivotably articulated but can also have a certain elasticity itself. The elasticity or elastic deformability can be realized in various ways. Thus, the ring structure can be made at least partially from an elastic material and/or have at least one correspondingly elastic insert. The ring structure can be elastically deformed, in particular by pressing the ring structure or the funnel bottom side against the printed circuit board. The desired fixing of the printed circuit board can thus be realized particularly easily and reliably.

Furthermore, it is possible that in a rotation angle sensor unit of the invention at least one shaped groove on the funnel bottom side can be is designed as a recess in the ring structure, wherein the at least one shaped groove extends at least in part between an inner edge of the ring structure and an outer edge of the ring structure. By using or designing the shaped groove, there is no need for additional inserts to realize the desired elasticity of the ring structure. This means that the desired elastic deformation of the ring structure can also be realized via the at least one shaped groove without particularly elastic material or corresponding inserts in the ring structure. The at least one shaped groove preferably extends straight in a radial direction between a radially inner area and a radially outer area of the ring structure. Nevertheless, the at least one groove can also extend at least partially in a circumferential direction of the ring structure and/or obliquely to the radial direction. The fact that the at least one shaped groove extends at least in part between the inner edge of the ring structure and the outer edge of the ring structure can be that the at least one shaped groove extends, for example, from a radially central region of the ring structure to the outer edge and/or to the inner edge. The shaped groove can be a groove to increase the elastic deformability of the ring structure. The shaped groove can therefore also be a correspondingly shaped recess in the ring structure, a slot, and/or a channel.

In a rotation angle sensor unit according to the present invention, it is also possible that a plurality of shaped grooves each can extend in the radial direction from the inner edge to the outer edge. The shaped grooves are preferably arranged in a star shape and/or at a distance in a range between 20° and 90°, in particular between 30° and 80°, from one another. The shaped grooves can prevent a “snap action effect” that could occur on the ring structure without the shaped grooves after the printed circuit board is subjected to pressure by the ring structure. Moreover, a particularly uniform elasticity of the ring structure can be achieved through the shaped grooves.

Moreover, it is possible that in a rotation angle sensor unit of the invention, the cover including the funnel-shaped ring structure is designed in one piece and/or as a monolithic component. For this reason, the cover can be provided particularly easily and with correspondingly simple logistics.

In a rotation angle sensor unit according to the present invention, the cover can be welded to the housing. A reliable pressure application to the printed circuit board can also be achieved thereby via the ring structure. During the production of the rotation angle sensor unit, the cover is only welded to the housing when the cover is positioned on the housing with elastic deformation of the ring structure due to the ring structure being pressed against the printed circuit board. A positive fit between the housing and the cover can be produced by welding in a simple and reliable way.

The cover in a rotation angle sensor unit can have a positioning contact section and for the housing to have a positioning mating contact section, wherein the positioning contact section for aligning the cover on the housing is positioned in and/or on the positioning mating contact section. Using the positioning contact section and the positioning mating contact section, the ring structure can be positioned particularly easily and reliably at the desired location on the housing and on the printed circuit board. The positioning contact section and the positioning mating contact section can each have multiple pins and multiple associated recesses for receiving the pins.

In addition, it is possible for the cover of a rotation angle sensor unit of the invention to have a bearing edge, at least partially adjacent to the funnel-shaped ring structure, with a bearing side, wherein the bearing side extends parallel to the printed circuit board. A precise alignment of the cover relative to the housing and thus also of the ring structure relative to the printed circuit board can also be achieved thereby in a simple manner. Moreover, a secure fit of the cover on the housing can be ensured thereby in a simple manner. The bearing edge can be an edge section that extends partially around the ring structure and/or adjoins an outer edge of the ring structure in a direction of rotation. The at least one shaped groove described above preferably extends from the inner edge of the ring structure to the outer edge of the ring structure and thus to the bearing edge on which the cover rests on the housing or contacts the housing. However, the at least one shaped groove preferably does not extend into or through the bearing edge, therefore, only up to an edge area thereof.

A cover for a rotation angle sensor unit as described above or for use in such a rotation angle sensor unit and/or for closing the housing used therein is also proposed. The cover is characterized in particular by the funnel-shaped ring structure with the funnel upper side and the funnel bottom side. Thus, the cover of the invention provides the same advantages as have been described in detail with reference to the device of the invention.

In a cover of the invention, a circular or annular pressure section can be formed on the funnel bottom side for applying pressure to the printed circuit board. Further, the funnel-shaped ring structure can be designed to be elastically deformable. Moreover, it is possible that at least one shaped groove is formed as a recess in the ring structure on the funnel bottom side, wherein the at least one shaped groove extends at least in part between an inner edge of the ring structure and an outer edge of the ring structure, and/or that a plurality of shaped grooves each extend in the radial direction from the inner edge to the outer edge.

A further aspect of the invention relates to a method for producing a rotation angle sensor unit as described above. The method has the following steps: providing the housing; positioning the printed circuit board in the housing; positioning the cover on the housing and thereby pressing the funnel bottom side against the circuit board; and attaching, in particular welding, the cover on or to the housing.

The cover can be pressed against the housing with a certain pretension during attachment, especially during welding, so that the funnel bottom side or the ring structure can press against the printed circuit board in the desired way and continue to maintain this function after welding. This means that in a method of the invention, it is possible for the funnel-shaped ring structure of the cover to be pressed against the printed circuit board in an elastically deformed manner during the attachment of the cover to the housing. The method can thus be used to produce a rotation angle sensor unit which also brings with it the advantages described above. Attachment can include welding, an alternative material bonding method, but also a positive and/or non-positive connection method. The attachment is carried out in such a way that the connection between the cover and the housing can then only be released using tools and/or by destroying the cover and/or the housing.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective representation of a rotation angle sensor unit according to an example;

FIG. 2 is a sectional side view of the rotation angle sensor unit shown in FIG. 1;

FIG. 3 is a perspective representation of a cover for the rotation angle sensor unit according to an example;

FIG. 4 is a sectional side view of the cover shown in FIG. 3;

FIG. 5 is a top plan view of a bottom side of the cover shown in FIG. 3 and FIG. 4; and

FIG. 6 is a flow chart explaining a method for producing the rotary angle sensor unit shown.

### DETAILED DESCRIPTION

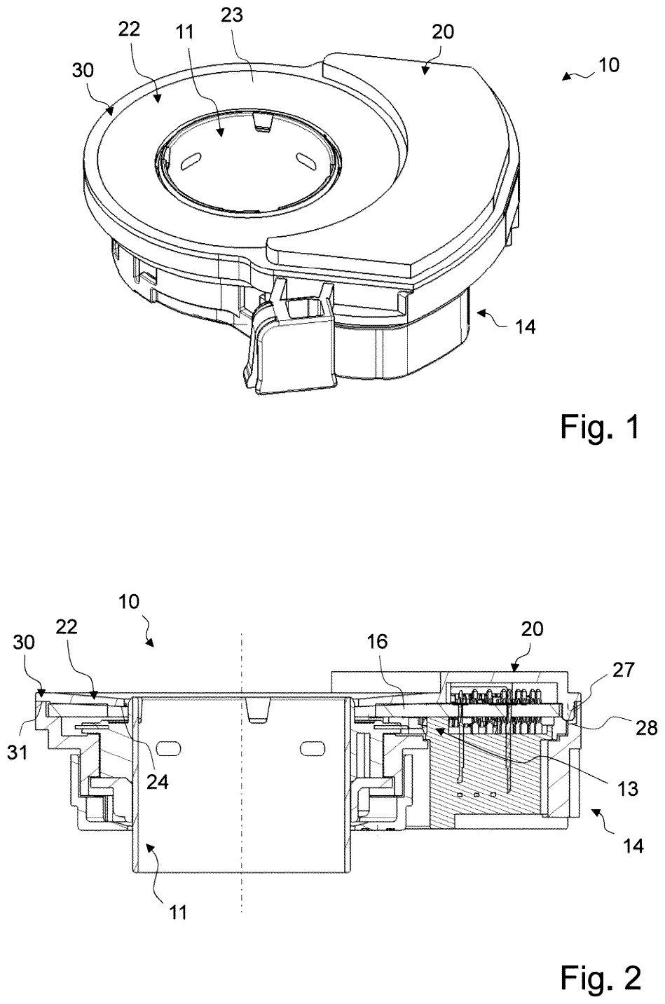

FIG. 1 shows a rotation angle sensor unit 10 for determining a rotation angle between a rotor 11 and a stator 13 of rotation angle sensor unit 10 shown in FIG. 2. Rotation angle sensor unit 10 comprises a housing 14 which defines a housing volume, and rotor 11 which is rotatably mounted in the housing volume. As shown in FIG. 1, cover 20 has a funnel-shaped ring structure 22 with an outward-facing funnel upper side 23. Cover 20, including funnel-shaped ring structure 22, is designed in one piece and as a monolithic component. In the example shown in FIG. 1, cover 20 is already welded to housing 14. Cover 20 has a bearing edge 30 partially adjoining funnel-shaped ring structure 22.

In FIG. 2, rotation angle sensor unit 10 is shown in more detail. Thus, looking at FIG. 2, it can be seen that rotation angle sensor unit 10 has a printed circuit board 16 to which stator 13 is attached. Cover 20 is configured to close housing 14 and thereby to enclose printed circuit board 16 in the housing volume. Cover 20 has a funnel bottom side 24, which presses against printed circuit board 16 or applies pressure to printed circuit board 16 accordingly in order to fix printed circuit board 16 in the housing volume and on housing 14. Funnel bottom side 24 therefore points into the housing volume or into housing 14. Looking at FIG. 2, it can be seen further that bearing edge 30 has a bearing side 31 which extends parallel to printed circuit board 16 and which rests on a corresponding edge structure of housing 14. FIG. 2 further shows that cover 20 has a peg-shaped positioning contact section 27 and housing 14 has a positioning mating contact section 28 in the form of a complementary recess in housing 14, which is why positioning contact section 27 is positioned in positioning mating contact section 28 for aligning cover 20 with housing 14.

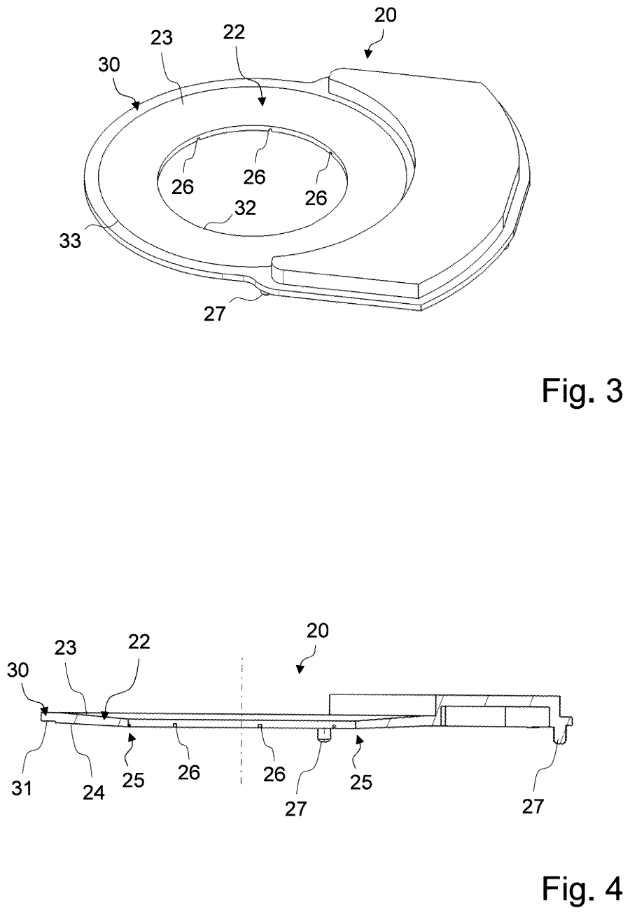

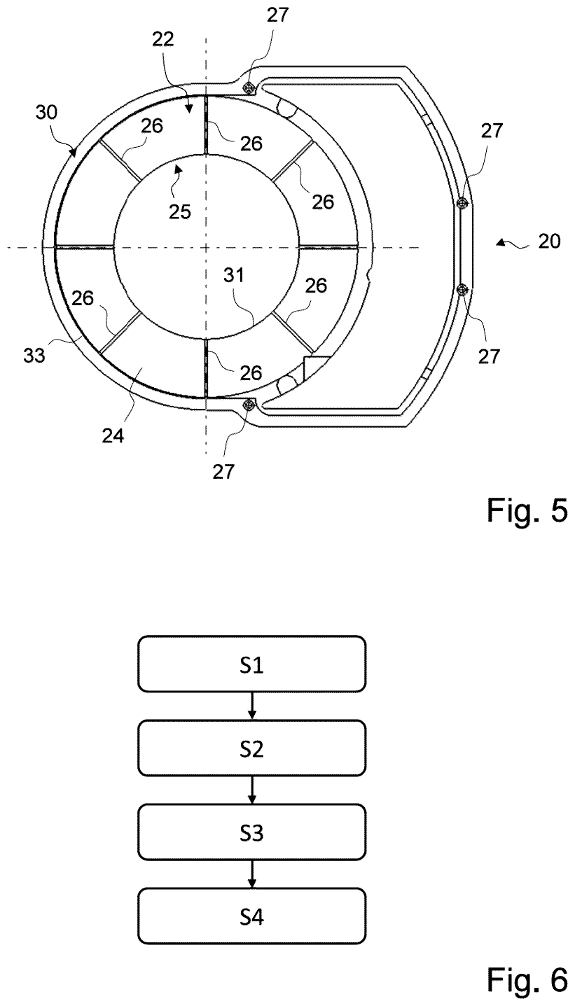

In FIGS. 3 to 5, cover 20 is shown separated from housing 14 and from the rest of rotation angle sensor unit 10. In FIGS. 3 to 5, the peg- or pin-shaped positioning contact sections 27 can be seen in particular. In addition, shaped grooves 26 can be seen in FIGS. 3 to 5 on funnel bottom side 24; these are formed as recesses in ring structure 22 and extend in the radial direction in each case from inner edge 32 to outer edge 33 but not beyond. Funnel-shaped ring structure 22 has an elastic deformability via shaped grooves 26. Furthermore, it can be seen in particular in FIG. 5 that a circular pressure section 25 or an annular contact edge for applying pressure to printed circuit board 16 is formed on funnel bottom side 24.

With reference to FIG. 6, a method for producing a rotation angle sensor unit 10 as described above will be explained next. In a first step S1, housing 14 is provided first. Printed circuit board 16 is then positioned in the housing volume in a step S2. Cover 20 is then positioned on housing 14 in a step S3 so that funnel bottom side 24 presses against printed circuit board 16. Cover 20 is therefore pressed against housing 14 under pretension. In a step S4, cover 20 is now welded to housing 14, wherein funnel-shaped ring structure 22 of cover 20 is pressed elastically deformed against printed circuit board 16 during the welding of cover 20.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A rotation angle sensor unit to determine a rotation angle between a rotor and a stator, the rotation angle sensor unit comprising:
a housing that defines a housing volume;
a rotor that is rotatably mounted in the housing volume;
a stator;
a printed circuit board on which the at least one stator is attached; and
a cover for the housing to enclose the printed circuit board in the housing volume, wherein the cover has a funnel-shaped ring structure with a funnel upper side facing away from the printed circuit board and a funnel bottom side facing the printed circuit board, and
wherein the funnel bottom side for fixing the printed circuit board in the housing volume presses against the printed circuit board.

2. The rotation angle sensor unit according to claim 1, wherein a circular or annular pressure section is formed on the funnel bottom side for applying pressure to the printed circuit board.

3. The rotation angle sensor unit according to claim 1, wherein the funnel-shaped ring structure is elastically deformable.

4. The rotation angle sensor unit according to claim 1, wherein at least one shaped groove is formed as a recess in the ring structure on the funnel bottom side, wherein the at least one shaped groove extends at least in part between an inner edge of the ring structure and an outer edge of the ring structure.

5. The rotation angle sensor unit according to claim 4, wherein a plurality of shaped grooves each extend in the radial direction from the inner edge to the outer edge.

6. The rotation angle sensor unit according to claim 1, wherein the cover including the funnel-shaped ring structure is designed in one piece and/or as a monolithic component.

7. The rotation angle sensor unit according to claim 1, wherein the cover is welded to the housing.

8. The rotation angle sensor unit according to claim 1, wherein the cover has a positioning contact section and the housing has a positioning mating contact section, and wherein the positioning contact section aligns the cover on the housing and is positioned in and/or on the positioning mating contact section.

9. The rotation angle sensor unit according to claim 1, wherein the cover has a bearing edge at least partially adjoining the funnel-shaped ring structure with a bearing side, and wherein the bearing side extends substantially parallel to the printed circuit board.

10. A cover for a rotation angle sensor unit according to claim 1, wherein the cover has the funnel-shaped ring structure with the funnel upper side and the funnel bottom side.

11. The cover according to claim 10, wherein a circular or annular pressure section is formed on the funnel bottom side for applying pressure to the printed circuit board.

12. The cover according to claim 10, wherein the funnel-shaped ring structure is elastically deformable.

13. The cover according to claim 10, wherein at least one shaped groove is formed as a recess in the ring structure on the funnel bottom side, wherein the at least one shaped groove extends at least in part between an inner edge of the ring structure and an outer edge of the ring structure, and/or wherein a plurality of shaped grooves each extend in the radial direction from the inner edge to the outer edge.

14. A method for producing a rotation angle sensor unit according to claim 1, the method comprising:
providing the housing;
positioning the printed circuit board in the housing volume;
positioning the cover on the housing and thereby pressing the funnel bottom side against the circuit board; and
attaching the cover to the housing.

15. The method according to claim 14, wherein the funnel-shaped ring structure of the cover is pressed against the printed circuit board in an elastically deformed manner during the welding of the cover.
